(19) United States
(12) Patent Application Publication
(10) Pub. No.: US 2020/0166882 A1
(43) Pub. Date: May 28, 2020

(54) IMAGE FORMING APPARATUS, IMAGE ADJUSTMENT METHOD, AND PROGRAM

(71) Applicant: KONICA MINOLTA, INC., Tokyo (JP)

(72) Inventor: Takashi YAMASHITA, Tokyo (JP)

(73) Assignee: KONICA MINOLTA, INC., Tokyo (JP)

(21) Appl. No.: 16/673,871

(22) Filed: Nov. 4, 2019

(30) Foreign Application Priority Data
Nov. 26, 2018 (JP) 2018-220105

(51) Int. Cl. G03G 15/00

(52) U.S. Cl. CPC G03G 15/5062

(57) ABSTRACT

An image forming apparatus includes an image former that forms and fixes an image of the adjustment chart on the sheet, an image reader that reads the adjustment chart formed on the sheet, a front and back adjuster that performs the front and back adjustment on a basis of the adjustment chart that is formed and fixed by the image former and read by the image reader, an image coverage rate calculator that calculates in advance an image coverage rate of the sheet included in one job to be executed by the image former, and a chart coverage rate determiner that determines a coverage rate of the adjustment chart to be formed on a front side of the sheet on a basis of the image coverage rate calculated by the image coverage rate calculator.

The entire disclosure of Japanese patent Application No. 2018-220105, filed on Nov. 26, 2018, is incorporated herein by reference in its entirety.

### BACKGROUND

### Technological Field

The present invention relates to an image forming apparatus, an image adjustment method, and a program.

### Description of the Related art

In an image forming apparatus such as a copying machine or a printer, information of images on both sides of a sheet, a position or magnification may be shifted of the images on printing surfaces, due to shrinkage of the sheet by fixing, positional shift of the sheet by passing through a duplex conveyance path for reversing and supplying the sheet again to an image former, or the like.

To eliminate such a shift of the image, “front and back adjustment” is performed. As “front and back adjustment”, it is known that an adjustment chart formed by a line diagram is formed at predetermined positions on the front side and back side of the sheet, an amount of shift is detected of the adjustment chart formed on each of the front side and back side, and the position and magnification of the image is adjusted so that the shift on the printing surface is eliminated (for example, JP 2007-3966 A).

However, since a shrinkage factor of a sheet after fixing varies depending on a coverage rate of an image formed on the sheet, in a case where the coverage rate of the image on the front side is high at the time of duplex printing, the shrinkage factor increases of the sheet after passing through a fixing device, and the size of the sheet is reduced. For this reason, information of an image on the back side, there has been a problem that a difference occurs from a result of adjustment using the adjustment chart formed by the line diagram, and the image formed on the back side is shifted.

### SUMMARY

The present invention has been made in view of the above problem in the conventional technique, and it is intended to reduce the shift of the image printed on the back side of the sheet, and improve the image quality of a printed matter, in duplex printing.

To achieve the abovementioned object, according to an aspect of the present invention, there is provided an image forming apparatus that performs front and back adjustment of images to be formed on both sides of a sheet by using an adjustment chart, and the image forming apparatus reflecting one aspect of the present invention comprises: an image former that forms and fixes an image of the adjustment chart on the sheet; an image reader that reads the adjustment chart formed on the sheet; a front and back adjuster that performs the front and back adjustment on a basis of the adjustment chart that is formed and fixed by the image former and read by the image reader; an image coverage rate calculator that calculates in advance an image coverage rate of the sheet included in one job to be executed by the image former; and a chart coverage rate determiner that determines a coverage rate of the adjustment chart to be formed on a front side of the sheet on a basis of the image coverage rate calculated by the image coverage rate calculator.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an image forming apparatus according to an embodiment of the present invention;

FIG. 2 is a block diagram illustrating, a functional configuration of the image forming apparatus according to the embodiment of the present invention;

FIG. 3 is an example of a front and back adjustment chart formed by a line diagram according to the embodiment of the present invention;

FIGS. 4A and 4B are examples of an adjustment chart formed by combining the line diagram and a patch diagram according to the embodiment of the present invention;

FIG. 5 is a diagram illustrating an example of image coverage rates of sheets included in one job;

FIG. 6 is a diagram illustrating an example of a chart coverage rate setting screen of the image forming apparatus according to the embodiment of the present invention;

FIGS. 7A and 7B are diagrams illustrating an example of the image coverage rate and a sheet feeding tray from which the sheet is fed, for each page of the sheets included in the one job;

FIG. 8 is an example of a color adjustment patch formed by a chart generator according to the embodiment of the present invention;

FIG. 9 is a flowchart illustrating front and back adjustment processing executed in the image forming apparatus according to the embodiment of the present invention; and

FIG. 10 is a flowchart illustrating the front and back adjustment processing to be automatically executed in the image forming apparatus according to the embodiment of the present invention.

### DETAILED DESCRIPTION OF EMBODIMENTS

Hereinafter, one or more embodiments of the present invention (hereinafter, referred to as “this example”) will be described with reference to the drawings. However, the scope of the invention is not limited to the disclosed embodiments. Note that, in the present specification and the drawings, components having substantially the same function or configuration will be denoted by the same reference numerals, and redundant descriptions will be omitted.

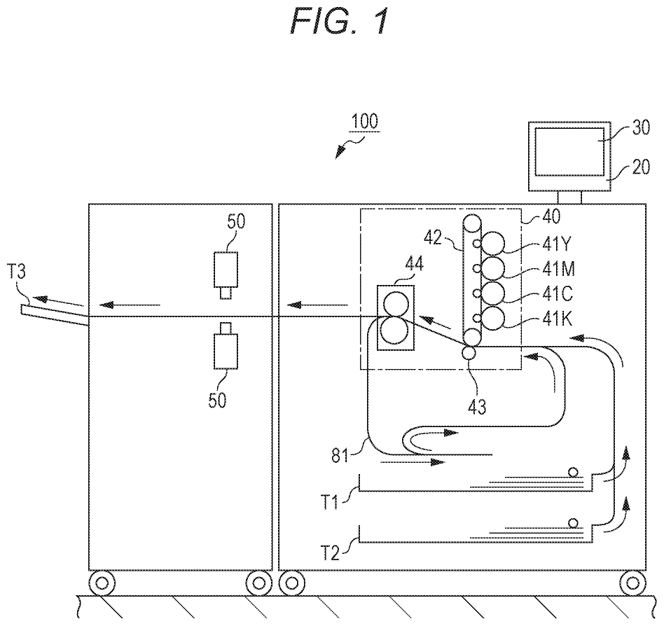

FIG. 1 is a schematic configuration diagram of an image forming apparatus 100 of this example.

As illustrated in FIG. 1, the image forming apparatus IOU includes an operation unit 20, a display unit 30, an image former 40, an image reader 50, a duplex conveyance path 81, sheet feeding trays T1 and T2, a sheet ejection tray T3, and the like.

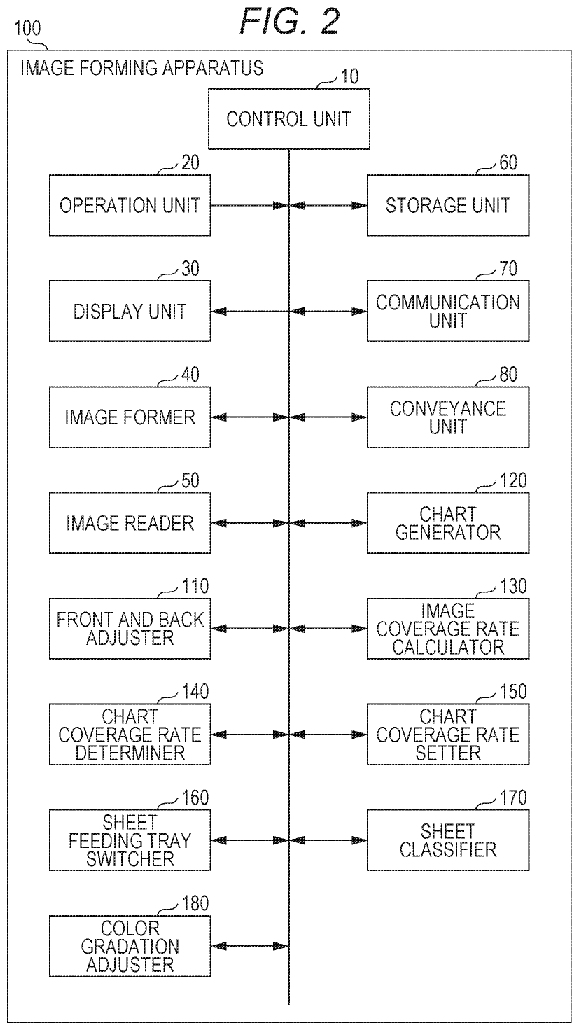

The operation unit 20 includes a touch panel formed to cover a display screen of the display unit 30, and various operation buttons such as a numeric button, and a start button, and outputs an operation signal based on operation of a user to the control unit 10 (see FIG. 2).

The display unit 30 includes a liquid crystal display (LCD), and displays various screens in accordance with instructions of display signals input from the control unit 10.

The image former 40 forms an image on a sheet on the basis of image data.

The image former 40 includes photoreceptor drums 41Y, 41M, 41C, and 41K corresponding to respective colors of yellow (Y), magenta (M), cyan (C), and black (K), an intermediate transfer belt 42, a secondary transfer roller 43, a fixing unit 44, and the like.

The photoreceptor drum 41Y is uniformly charged, and then scanned and exposed by a laser beam on the basis of image data of a yellow color, and an electrostatic latent image is formed. Then, toner of the yellow color is caused to adhere to the electrostatic latent image on the photoreceptor drum 41Y, and development is performed.

The photoreceptor drums 41M, 41C, and 41K are the same as the photoreceptor drum 41Y except that the colors to be treated are different, and thus the description thereof will be omitted.

Toner images of the respective colors formed on the photoreceptor drums 41Y, 41M, 41C, and 41K are sequentially transferred onto the intermediate transfer belt 42 rotating (primary transfer). That is, a color toner image on which toner images of four colors are superimposed is formed on the intermediate transfer belt 42.

The color toner images on the intermediate transfer belt 42 are collectively transferred onto tile sheet by the secondary transfer roller 43 (secondary transfer).

The fixing unit 44 includes a heating roller that heats the sheet on which the color toner image is transferred, and a pressure roller that presses the sheet, and fixes the color toner image on the sheet by heating and pressing.

The image reader 50 includes a line sensor in which a plurality of light receiving elements is arranged at predetermined intervals in a direction orthogonal to a sheet conveyance direction, and. reads contents (image and adjustment chart) formed. on the sheet, and read data (image data) is output to the control unit 10. Each light receiving, element outputs a signal corresponding to an intensity of light emitted from a light source and reflected by the front side of the sheet,. As the line sensor, for example, a charge coupled device (CCD) sensor or a complementary metal oxide semiconductor (CMOS) sensor is used. Note that, the contents printed on both sides of the sheet are read by the image reader 50 installed above and the image reader 50 installed below

The duplex conveyance path 81 is a conveyance path for reversing the front and back of the sheet and supplying the sheet to the image former 40 again in a case where images are formed on both sides of the sheet. That is, the image formed on the front side of the sheet is printed, and then the image formed on the back side of the sheet is printed.

In the sheet feeding trays T1 and T2, sheets of a predetermined sheet type and size are stored. The sheets stored in the sheet feeding trays T1 and T2 are supplied to the image former 40 one by one.

In addition, the sheet after image minting is ejected to the sheet ejection tray T3.

In this example, different front and back adjustment values are set for respective trays of the sheet feeding, tray T1 and the sheet feeding tray T2. Here, the front and back adjustment value means an amount of correction (adjustment value) used when front and back adjustment described later is performed. Note that, in this example, the number of sheet feeding trays installed is two, but three or more sheet feeding trays may be installed and three or more different front and back adjustment values may exist. In addition, a plurality of different front and back adjustment values may be given to one sheet feeding tray.

FIG. 2 is a block diagram illustrating a functional configuration of the image forming apparatus 100.

As illustrated in FIG. 2, the image forming apparatus 100 includes the control unit 10, the operation unit 20, the display unit 30, the image former 40, the image reader 50, a storage unit 60, a communication unit 70, a conveyance unit 80, and a front and back adjuster 110, a chart generator 120, an image coverage rate calculator 130, a chart coverage rate determiner 140, a chart coverage rate setter 150, a sheet feeding tray switcher 160, a sheet classifier 170, a color gradation adjuster 180, and the like. Note that, the description will be omitted of functional units already described.

The control unit 10 includes a central processing unit (CPU), read only memory (ROM), random access memory (RAM), and the like. The CPU reads various processing programs stored in the ROM and deploys the programs into the RAM depending on an operation signal input from the operation unit 20 or an instruction signal received by the communication unit 70, and centrally controls operation of each unit of the image forming apparatus 100 in accordance with the programs deployed.

The storage unit 60 includes a hard disk, a flash memory, or the like, and stores various data. The storage unit 60 stores sheet information regarding sheets stored in the sheet feeding tray T1 and the sheet feeding tray T2. The sheet information includes a basis weight of the sheet, a sheet type, and the like. In addition, the storage unit 60 stores the front and back adjustment values set for the sheet feeding tray T1 and the sheet feeding tray T2.

The communication unit 70 transmits and receives data to and from an external device connected to a communication network such as a local area network (LAN).

The conveyance unit 80 includes a conveying roller for conveying a sheet, and conveys the sheet in the image forming apparatus 100.

The chart generator 120 causes the image former 40 to generate an image (front and back adjustment chart, patch) of the adjustment chart to be used for the front and back adjustment and form the image on the sheet.

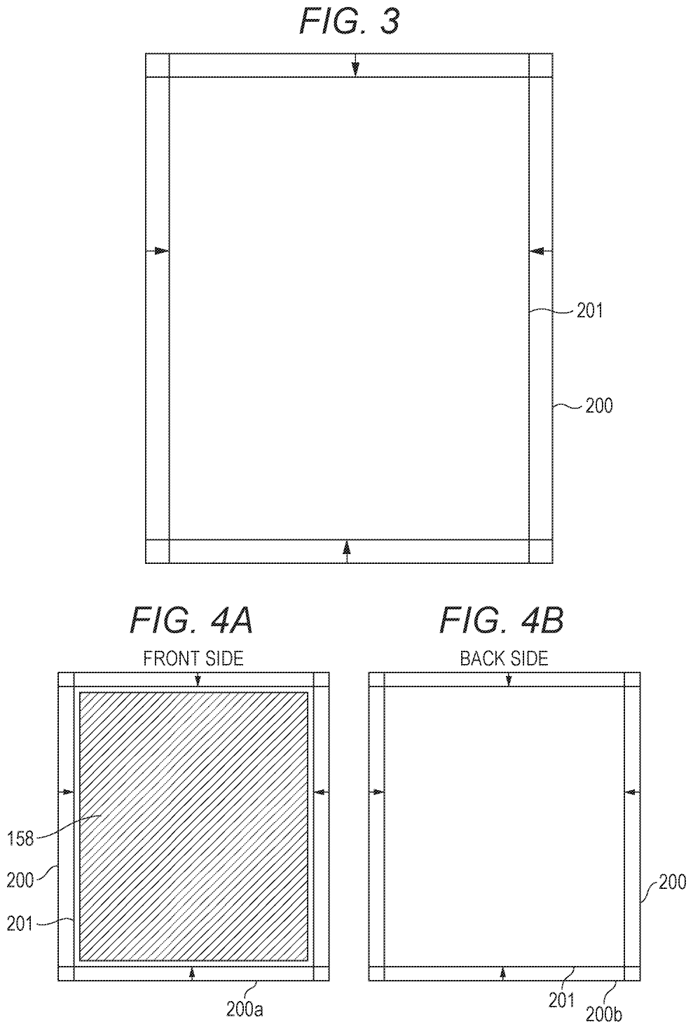

FIG. 3 is an example of the front and back adjustment chart formed by a line diagram generated by the chart generator 120.

As illustrated in FIG. 3, the image of the front and back adjustment chart of this example is formed by a straight line diagram drawn at a position separated by a predetermined distance from the edge of the sheet.

FIGS. 4A and 4B are examples of the adjustment chart generated by the chart generator 120 and formed by combining the line diagram and the patch diagram.

As illustrated in FIG. 4A, the adjustment chart (adjustment image) of this example is formed by combining a front and back adjustment chart 201 of a straight line diagram drawn at a position separated by a predetermined distance from the edge of a chart sheet 200, and a patch 158 including a set of oblique lines formed inside the front and back adjustment chart 201, and is formed on a front side 200a of the chart sheet 200. Note that, as illustrated in FIG. 4B, only the front and back adjustment chart 201 is formed on a back side 200b of the chart sheet 200.

The front and back adjuster 110 included in the control unit 10 calculates amounts of correction of an image position, an image density, a color shift, and the like on the basis of the read data obtained by reading the adjustment image such as the adjustment chart by the image reader 50, and performs the front and back adjustment by feeding back the adjustment values to positions and magnifications of the images to be formed on the front side and back side of the sheet, regarding formation of an actual image to be performed on the sheet thereafter.

The image coverage rate calculator 130 calculates in advance for each page of the sheet the coverage rate (image coverage rate) of the image to be formed on the sheet included in one job to be executed by the image former 40, before forming the actual image on the sheet.

The chart coverage rate determiner 140 determines the coverage rate of the adjustment chart to be formed on the front side of the chart sheet on the basis of the image coverage rate calculated by the image coverage rate calculator 130.

The chart coverage rate setter 150 is for manually setting the coverage rate of the adjustment chart to be formed on the front side of the sheet, and can be operated on the screen of the touch panel of the operation unit 20, for example.

The sheet feeding tray switcher 160 switches the sheet feeding trays that feed the sheet for forming the actual image, on the basis of the image coverage rate of the sheet included in the one job, the image coverage rate being calculated by the image coverage rate calculator 130. The switching of the sheet feeding trays is performed manually or automatically.

The sheet classifier 170 classifies the sheets included in the one job into a plurality of groups on the basis of the image coverage rates of the images to be formed on the sheets included in the one job, the image coverage rates each being calculated by the image coverage rate calculator 130. For example, the sheet classifier 170 classifies into the same group the sheets whose coverage rates of images to be formed on the front side of the sheets are close to each other.

The color gradation adjuster 180 performs color shift adjustment of the image to be printed on the sheet by using a color adjustment patch 168 generated by the chart generator 120. The color gradation adjuster 180 calculates an amount of correction (adjustment value) of the color gradation on the basis of the read data obtained by reading a color adjustment patch image by the image reader 50, and performs color adjustment by feeding back the adjustment value to the color gradation of the image to be formed on the front side and back side of the sheet, regarding formation of the actual image to be performed on the sheet thereafter.

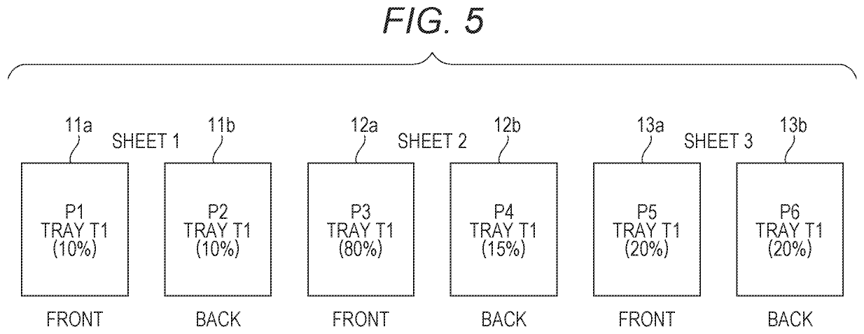

FIG. 5 is a diagram illustrating an example of the image coverage rate for each page of the sheets included in one job to be executed by the image former 40 of the image forming apparatus 100, the image coverage rate being calculated by the image coverage rate calculator 130.

The image coverage rate of each page is calculated by the image coverage rate calculator 130 on the basis of data of the actual image to be formed on each sheet when a signal of job execution is input by the operation unit 20.

As illustrated in FIG. 5, contents of the one job of this example are six pages (P1 to P6) of printing an image on both sides (front side and back side) of three sheets (sheet 1, sheet 2, sheet 3), and the coverage rate of the front side 11a (P1) of the first sheet (sheet 1) is 10%, and the coverage rate of the back side 11b (P2) is also 10%. The coverage rate of the front side 12a (P3) of the second sheet (sheet 2) is 80%, and the coverage rate of the back side 12b (P4) is 15%. The coverage rate of the front side 13a (P5) of the third sheet (sheet 3) is 20%, and the coverage rate of the back side 13b (P6) is 20%. Note that, the coverage rate of the front side 12a (P3) of the sheet 2 of the third page is 80%, which is high, so that it can be seen that a solid image is formed on this page with a large amount of toner used, such as a picture. In addition, the sheets used in the one job of this example are all fed from the same sheet feeding tray T1.

In this example, the chart coverage rate determiner 140 determines the coverage rate of the adjustment chart to be formed on P1 of the chart sheet to be 10%, the coverage rate of the adjustment chart to be formed on P3 to be 80%, and the coverage rate of the adjustment chart to be formed on P5 to be 20% on the basis of the image coverage rate of each sheet calculated by the image coverage rate calculator 130. The chart generator 120 generates adjustment images including patch images of coverage rates of 10%, 20%, and 80% on the basis of the determination of the chart coverage rate determiner 140, and the image former 40 forms these adjustment images as adjustment charts on the front side (P1, P3, P5) of the chart sheet.

The image reader 50 reads the adjustment chart printed on the chart sheet, and calculates the amounts of correction (adjustment value) of the image position, the image density, the color shift, and the like on the basis of the read data, whereby a shrinkage factor of the sheet can be obtained. Regarding formation of the actual image to be performed on the sheet thereafter, it is possible to perform the front back adjustment by feeding back the adjustment values to the position and magnification of the image to be formed on the front side of the sheet, and supply the sheet from a sheet feeding tray having an optimum front and back adjustment value depending on the shrinkage factor. As described above, according to the image forming apparatus 100 of this example, it is possible to perform accurate front and back adjustment by calculating the coverage rate of the actual image in advance and setting the coverage rate as the coverage rate of the adjustment chart. As a result, an image shift can be reduced of the back side of the sheet printed, and tile image quality can be improved of the printed matter.

The image coverage rate calculator 130 may calculate an average image coverage rate by adding the coverage rates of the pages P1 to P6 and dividing the added coverage rates by the total number of pages. The chart coverage rate determiner 140 determines the average image coverage rate calculated by the image coverage rate calculator 130 as the coverage rate of the adjustment chart to be formed on the front side of the sheet, and the chart generator 120 generates adjustment images including a patch image having the average image coverage rate. The image former 40 forms these adjustment images on the front side of the sheet as the adjustment charts. The image reader 50 reads the adjustment image having the average image coverage rate printed on the front side of the chart sheet, and performs feedback on the front and back adjustment. By making the shrinkage factor of the sheet constant, the sheet can be supplied from the same sheet feeding tray having the optimum front and back adjustment value, so that printing speed can be increased of the job.

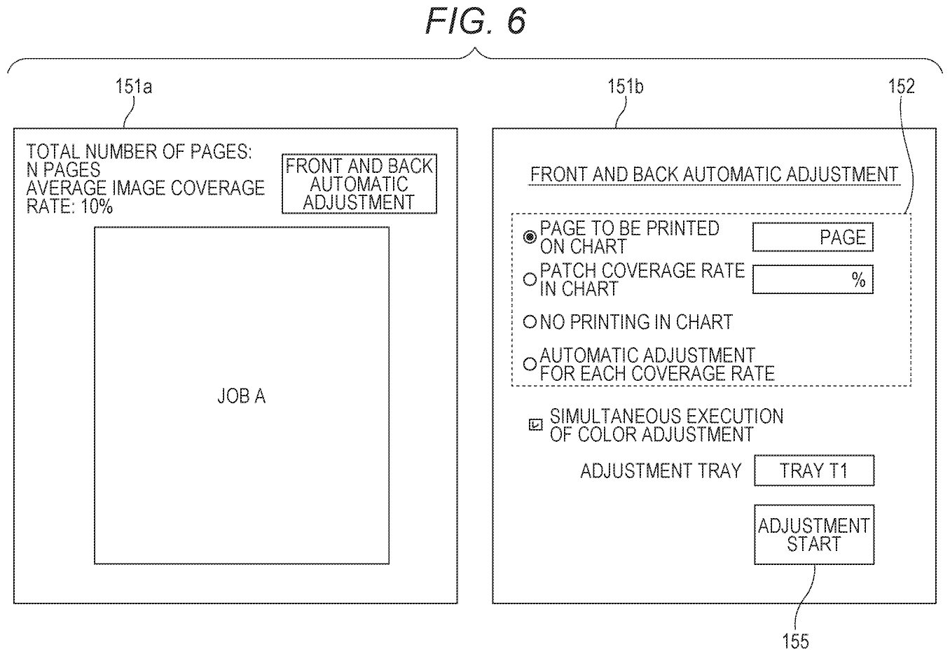

FIG. 6 is a diagram illustrating an example of a chart coverage rate setting screen 151 as the chart coverage rate setter 150 of this example.

The chart coverage rate setting screen 151 is provided, for example, on the screen of the touch panel of the operation unit 20, and the user can set an arbitrary coverage rate of the adjustment chart.

As illustrated in FIG. 6, an outline of one job to be executed by the image former 40 is displayed on a chart coverage rate setting screen 151a. in the central portion of the setting screen 151a, the first page is displayed to which the title (JOB A) of the job is attached. The user can confirm the content of the image to be formed on each page by, for example, scrolling the screen. Note that, the contents of the job may be displayed in a thumbnail format that can be listed. At the upper left of the setting screen 151a, the total number of pages of the one job and the average image coverage rate calculated by the image coverage rate calculator 130 are displayed. That is, the user can compare the average image coverage rate with the content of the image of each page in the one job on the setting screen 151a.

Ina selection area 152 of a chart coverage rate setting screen 151b, selectable items are displayed regarding the adjustment chart to be used for the front and back adjustment. As the selectable items, “page to be printed on chart”, “patch coverage rate in chart”, “no printing in chart”, and “automatic adjustment for each coverage rate” are displayed.

In a case where an image on a specific page in the one job is used as the adjustment chart, the user designates “page to be printed on chart” and inputs in the box a page number of the sheet on which the image is formed. When the page number is input in the box, the control unit 10 controls the image former 40 to form the image of the page entered in the box on the front side of the chart sheet as the image of the adjustment chart.

In a case where the coverage rate of the adjustment chart is optionally set, the user designates “patch coverage rate in chart” and inputs an arbitrary numerical value in the box. When the arbitrary numerical value is input in the box, the chart generator 120 generates an adjustment image as tile adjustment chart having a coverage rate of the input arbitrary value, and forms the adjustment image on the front side of the chart sheet. Note that, in a case where a value of the average image coverage rate displayed on the setting screen 151a is 10%, the user normally inputs a value of 10% in the box of “patch coverage rate in chart”, but in a case where, for example, there is an image with a high coverage rate, such as a picture with high necessity for suppressing image shift in the one job in confirmation on the setting screen 151a, the value input to the box may be made larger than 10%. As a result, a shift can be positively suppressed that occurs in an image with a high coverage rate.

In a case where it is not necessary to use the patch image, the user designates “no printing in chart”. For example, in a case where the image in the one job is formed by only images such as line diagrams having small coverage rates, influence is small even if an image shift occurs, so that “no printing in chart” may be designated.

In a case where it is desired to cause the front and back adjustment to be automatically performed depending on the image coverage rate of each page of the sheets in the one job, “automatic adjustment for each coverage rate” is designated. In a case where “automatic adjustment for each coverage rate” is designated, the chart generator 120 generates adjustment images respectively corresponding to the coverage rates calculated by the image coverage rate calculator 130, and respectively forms the adjustment images on the corresponding front sides of the chart sheets.

In a case where it is desired to execute the color shift adjustment simultaneously with the front and back adjustment of the printing image, the user inputs a check in a check box of “simultaneous execution of color adjustment”. Ina case where the check is entered in the check box, the color gradation adjuster 180 forms a color adjustment patch generated by the chart generator 120 on the chart sheet and performs color shift adjustment.

In a case where it is desired to designate a sheet feeding tray that feeds a sheet on which an image is to be formed, the user inputs the number of the sheet feeding tray in the box of “adjustment tray”. In this example, the sheet feeding tray T1 is designated as the sheet feeding tray. Selection of the sheet feeding tray may be optionally performed by the user via the setting screen 151b on the basis of the front and back adjustment value of each sheet feeding tray, or the sheet feeding tray may be automatically selected on the basis of the image coverage rate calculated by the image coverage rate calculator 130.

After the input of the items on the setting screen 151b is completed, the user presses an adjustment start button 155, whereby the front and back adjustment is started.

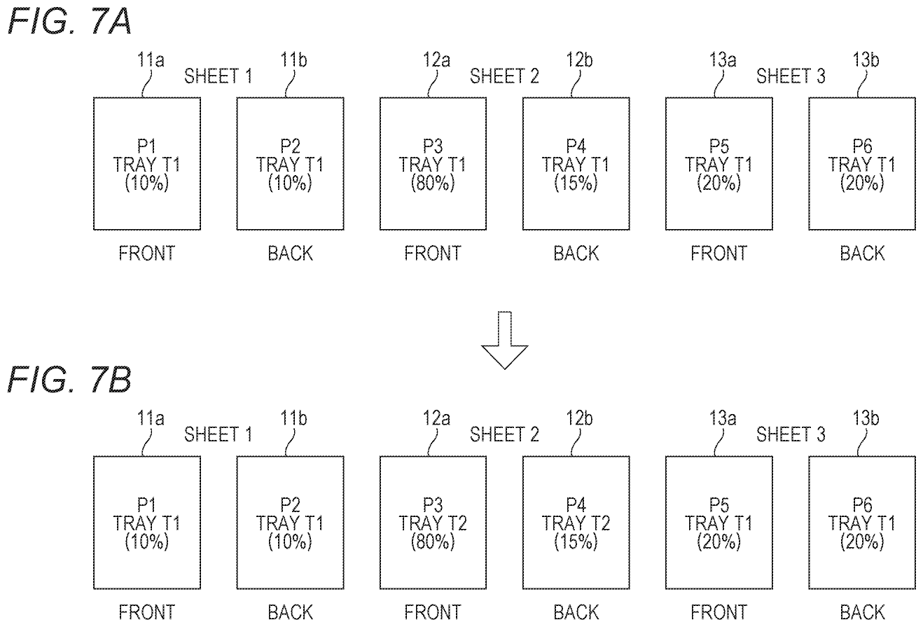

Next, with reference to FIGS. 7A and 7B, a procedure will be described of classifying sheets included in one job into a plurality of groups on the basis of the image coverage rate calculated by the image coverage rate calculator 130 by the sheet classifier 170.

FIG. 7A illustrates the contents of the one job described in FIG. 5, and detailed description will be omitted.

As illustrated in FIG. 7A, the coverage rate of the front side 11a of the sheet 1 is 10%, the coverage rate of the front side 12a of the sheet 2 is 80%, and the coverage rate of the front side 13a of the sheet 3 is 20%. In such a case, the sheet classifier 170 of this example classifies into the same group the sheets having close image coverage rates of the front side of the sheet. Here, a threshold value of the image coverage rate for classification is set to 30%, the sheet 1 and the sheet 3 are set as the same group, the sheet 2 is set as another group, and the sheets are classified into those having close shrinkage factors of the sheet shrinkage generated when images are printed. Note that, in this example, the threshold value of the image coverage rate for classification is set to 30%, but this threshold value can be set as appropriate.

When the sheets in the one job are classified by the sheet classifier 170, the sheet feeding tray switcher 160 automatically performs switching of the sheet feeding trays that feed the sheets. In this example, as illustrated in FIG. 7B, the sheet feeding tray is switched so that the sheet is fed from the sheet feeding tray T1 for the sheets (sheet 1 and sheet 3) classified into the group in which the image coverage rate on the front side of the sheet is small. In addition, the sheet feeding tray is switched so that the sheet is fed from the sheet feeding tray T2 for the sheets (sheet 2) classified into the group in which the image coverage rate of the front side of the sheet is large. As described above, in this example, by automatically switching to the sheet feeding tray in which an appropriate front and back adjustment value is set for the shrinkage factor of the sheet, the optimum sheet is supplied, so that the image shift can be suppressed on the back side of the sheet, and the image quality can be improved of the printed matter. Note that, in a case where a plurality of different front and back adjustment values is set in one sheet feeding tray, sheets can be fed from the same sheet feeding tray to different groups classified by the sheet classifier 170.

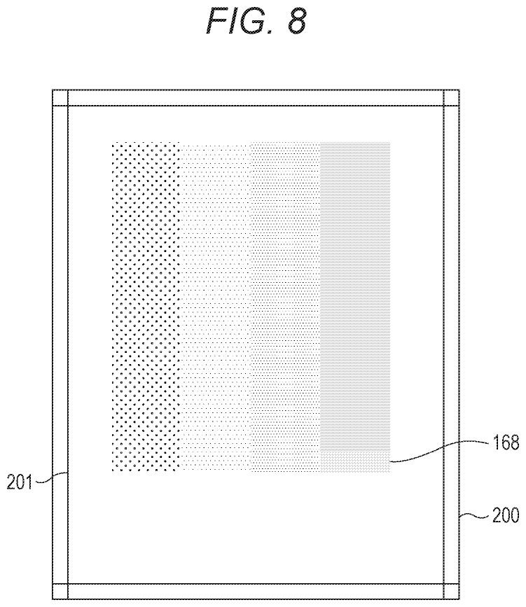

FIG. 8 is an example of the color adjustment patch formed by the chart generator 120 of this example.

As illustrated in FIG. 8, a color adjustment patch 168 is formed in a predetermined size, and has a predetermined image coverage rate. Note that, although it is possible to change the size (image coverage rate) of the color adjustment patch 168, if the size becomes too small, influence of surroundings becomes large, and there is a case where the amount of correction cannot be calculated of the color gradation.

In this example, since the color adjustment patch 168 is also used as the adjustment chart, the chart generator 120 causes the image former 40 to form the color adjustment patch 168 used for the color adjustment on the front side of the sheet as the adjustment chart. Note that, the image coverage rate of the color adjustment patch 168 is determined by the chart coverage rate determiner 140. As a result, the color shift can be suppressed of the image on the printed matter, and the shift of the image can also be suppressed by bringing the shrinkage factor close to that of the sheet of a case where the actual image is printed.

Note that, in a case where a value of the chart coverage rate determined by the chart coverage rate determiner 140 is small and the amount of correction of the color gradation cannot be calculated from the color adjustment patch 168, the color adjustment patch 168 is formed on the back side, not the front side, of the chart sheet, and the color adjustment is performed. In addition, in this case, a patch image 158 as the adjustment chart is separately generated by the chart generator 120, and is formed on the front side of the chart sheet, and the front and back adjustment is performed. As a result, even in a case where the chart coverage rate determined by the chart coverage rate determiner 140 is small, the color shift can be suppressed as well as the positional shift of the image on the printed matter.

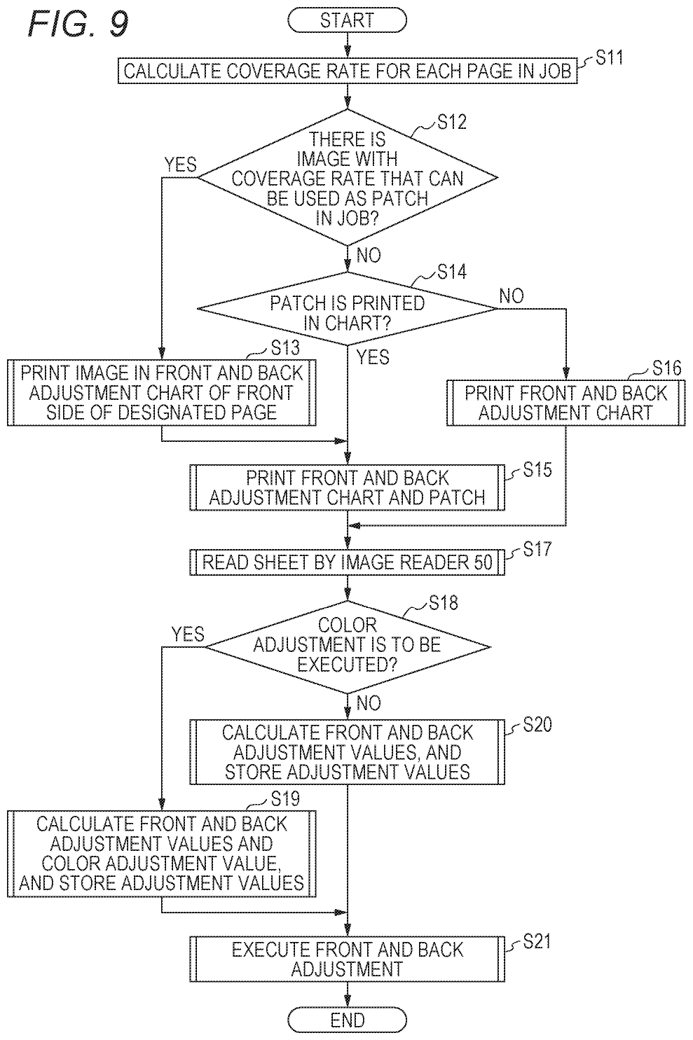

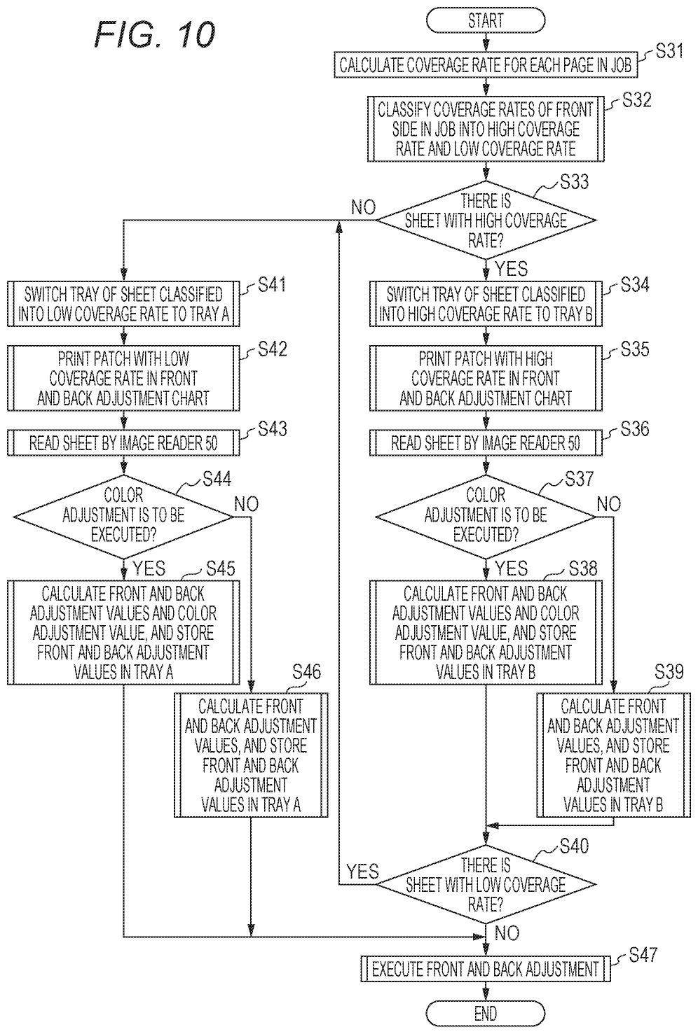

Next, with reference to FIGS. 9 and 10, examples will be described of front and back adjustment processing performed by the image forming apparatus 100 of this example.

FIG. 9 is a flowchart illustrating an example of the front and hack adjustment processing executed by the image forming apparatus 100 of this example.

As illustrated in FIG. 9, first, the image coverage rate calculator 130 calculates a coverage rate (image coverage rate) of an image to be formed on a sheet included in one job to be executed by the image former 40 in a page basis (S11).

Next, on the basis of the image coverage rate of each page calculated by the image coverage rate calculator 130, it is determined whether or not there is an image that can be used as a patch of an adjustment chart (S12). In a case where there is the image that can be used as the patch of the adjustment chart (Yes in S12), the page number of the corresponding image is input on the chart coverage rate setting screen 151b, and the image former 40 forms the image as a patch image on the front side of a chart sheet (S13). Thereafter, a front and back adjustment chart and the image are printed on the front side of the chart sheet (S15).

In step S12, in a case where there is no image that can be used as the patch of the adjustment chart (No in S12), it is determined whether or not the patch image needs to be formed inside the front and back adjustment chart of the chart sheet (S14).

In a case where it is determined in step S14 that the patch image needs to be formed inside the front and back adjustment chart (Yes in S14), “patch coverage rate in chart” is selected on the chart coverage rate setting screen 151b, and an arbitrary patch coverage rate is input. When the arbitrary patch coverage rate is input, the chart generator 120 generates a patch image having the coverage rate, and the front and hack adjustment chart and the patch image are printed on the front side of the chart sheet (S15). In a case where it is determined in step S14 that the patch image does not have to be formed inside the front and back adjustment chart (No in S14), only the front and back adjustment chart is printed on the front side of the chart sheet (S16).

Next, the image reader 50 reads the adjustment chart including the patch image printed on the chart sheet, and calculates amounts of correction (front and back adjustment values) of the image position and the like on the basis of the read data (S17).

Next, it is determined whether or not color adjustment is to be executed of the image to be printed, in addition to the front and back adjustment (S18). Specifically, it is determined whether or not a check is input in the check box of “simultaneous execution of color adjustment” of the chart coverage rate setting screen 151b.

In step S18, in a case where the color adjustment is to be executed (Yes in S18), the image reader 50 reads a color adjustment patch image printed on the chart sheet, and an amount of correction of the color shift (color adjustment value) is calculated on the basis of the read data. The calculated color adjustment value is stored in the storage unit 60 together with the front and back adjustment values calculated in step S17 (S19). In a case where the color shift adjustment is not to be executed in step S18 (No in S18), only the front and back adjustment values calculated in step S17 are stored in the storage unit 60 (S20).

Finally, on the basis of the adjustment values stored in the storage unit 60, the front and back adjuster 110 performs the front and back adjustment, including the color adjustment if necessary, on the image to be formed on the sheet (S21).

Next, with reference to FIG. 10, an example will be described of a case where the front and back adjustment processing is automatically performed.

FIG. 10 is a flowchart illustrating an example of the front and back adjustment processing to be automatically executed in the image forming apparatus 100 of this example.

As illustrated in FIG. 10, first, the image coverage rate calculator 130 calculates a coverage rate (image coverage rate) of an image to be formed on a sheet included in one job to be executed by the image former 40 in a page basis (S31).

Next, sheets included in the one job is classified into a sheet group with a high coverage rate and a sheet group with a low coverage rate by the sheet classifier 170 on the basis of the image coverage rates of the images to be formed on the front side of the sheet included in the one job, the image coverage rates each being calculated by the image coverage rate calculator 130 (S32).

Next, it is determined whether or not there is the sheet group with the high coverage rate among the sheet groups classified by the sheet classifier 170 in step S32 (S33). In a case where there is the sheet group with the high coverage rate (Yes in S33), by the sheet feeding tray switcher 160, a sheet feeding tray that feeds the sheet on which an image with the high coverage rate is to be formed is switched to a sheet feeding tray B (for example, the sheet feeding tray T1) for which an adjustment value for a high sheet shrinkage factor is set (S34). In a case where there is no sheet group with the high coverage rate (No in S33), it is a job in which only an image with the low coverage rate is to be formed, so that the processing proceeds to step S41 described later.

Next, the chart coverage rate determiner 140 sets the coverage rate of the adjustment chart on the basis of the high coverage rate calculated by the image coverage rate calculator 130, and the chart generator 120 generates a patch image having the coverage rate, and the front and back adjustment chart and the patch image are printed on the from side of the corresponding sheet of the chart sheet (S35).

Next, the image reader 50 reads the adjustment chart including the patch image printed on the chart sheet, and calculates amounts of correction (front and back adjustment values) of the image position and the like on the basis of the read data (S36).

Next, it is determined whether or not color adjustment is to be executed of the image to be printed, in addition to the front and back adjustment (S37). In step S37, in a case where the color adjustment is to be executed (Yes in S37), the image reader 50 reads a color adjustment patch image printed on the chart sheet, and an amount of correction of the color shift (color adjustment value) is calculated on the basis of the read data. The calculated color adjustment value is stored in the sheet feeding tray B as a storage unit together with the front and back adjustment values calculated in step S36 (S38). In a case where the color shift adjustment is not to be executed in step S37 (No in S37), only the front and back adjustment values calculated in step S35 are stored in the sheet feeding tray B (S39).

Next, it is determined whether or not there is a sheet group with the low coverage rate among the sheet groups classified in step S32 (S40). In a case where there is the sheet group with the low coverage rate (Yes in S40), to form mi image with the low coverage rate included in the job, the sheet feeding tray switcher 160 switches a sheet feeding tray to a sheet feeding tray A (for example, the sheet feeding tray T2) for which an adjustment value for a low sheet shrinkage factor is set (S41). In a case where there is no sheet group with the low coverage rate (No in S40), the job is one in which only an image with the high coverage rate is to be formed, so that the processing proceeds to step S47 described later, and necessary front and back adjustment is performed on the basis of each adjustment value stored in the sheet feeding tray B by the front and back adjuster 110 (S47).

Next, the chart coverage rate determiner 140 sets the coverage rate of the adjustment chart on the basis of the low coverage rate calculated by the image coverage rate calculator 130, and the chart generator 120 generates a patch image having the coverage rate, and the front and back adjustment chart and the patch image are printed on the front side of the Chart sheet (S42).

Next, the image reader 50 reads the adjustment chart including the patch image printed on the chart sheet, and calculates amounts of correction (front and back adjustment values) of the image position and the like on the basis of the read data (S43).

Next, it is determined whether or not color adjustment is to be executed of the image to be printed, in addition to the front and back adjustment (S44). In step S44, in a case where the color adjustment is to be executed (Yes in S44), the image reader 50 reads a color adjustment patch image printed on the chart sheet, and an amount of correction of the color shift (color adjustment value) is calculated on the basis of the read data. The calculated color adjustment value is stored in the sheet feeding tray A as a storage unit together with the front and back adjustment values calculated in step S43 (S45). In step S44, in a case where the color adjustment is not to be executed (No in S44), only the front and back adjustment values calculated in step S43 are stored in the sheet feeding tray A (S46).

Finally, the front and back adjuster 110 performs necessary front and back adjustment on the basis of the adjustment values stored in the sheet feeding tray A (S47).

As described above, according to the image forming apparatus 100 of this example, in duplex printing, by bringing the shrinkage factor close to that of the sheet of a case where the actual image is printed, the shift can be reduced of the image printed on the back side of the sheet, and the image quality can be improved of the printed matter.

Although embodiments of the present invention have been described and illustrated in detail, the embodiments described, above and illustrated in the drawings are made for purposes of illustration and example only and not limitation. The scope of the present invention should be interpreted by terms of the appended claims, and various modifications can be made without departing from the scope of the invention described in the claims. For example, the chart coverage rate setting screen 151 of this example is merely an example, and various layouts are conceivable,

What is claimed is:

1. An image forming apparatus that performs front and back adjustment of images to be formed on both sides of a sheet by using an adjustment chart,
the image forming apparatus comprising:
an image former that forms and fixes an image of the adjustment chart on the sheet;
an image reader that reads the adjustment chart formed on the sheet;
a front and back adjuster that performs the front and back adjustment on a basis of the adjustment chart that is formed and fixed by the image former and read by the image reader;
an image coverage rate calculator that calculates in advance an image coverage rate of the sheet included in one job to be executed by the image former; and
a chart coverage rate determiner that determines a coverage rate of the adjustment chart to be formed on a front side of the sheet on a basis of the image coverage rate calculated by the image coverage rate calculator.

2. The image forming apparatus according to claim 1, wherein
the chart coverage rate determiner determines the coverage rate of the adjustment chart to be formed on the front side of the sheet on a basis of an average image coverage rate obtained by averaging image coverage rates of sheets included in the one job, the image coverage rates each being calculated by the image coverage rate calculator.

3. The image forming apparatus according to claim 1, further comprising
a chart generator that generates a patch as the adjustment chart, wherein
the chart generator determines a coverage rate of the patch on the basis of the image coverage rate calculated by the image coverage rate calculator.

4. The image forming apparatus according to claim 3, further comprising
a chart coverage rate setter with which the coverage rate of the adjustment chart is manually set, wherein
the chart generator determines the coverage rate of the patch on a basis of the coverage rate set with the chart coverage rate setter.

5. The image forming apparatus according to claim 1, further comprising:
a plurality of sheet feeding trays for which different front and back adjustment values to perform the front and back adjustment are respectively set; and
a sheet feeding tray switcher that switches the sheet feeding trays on the basis of the image coverage rate of the sheet included in the one job, the image coverage rate being calculated by the image coverage rate calculator.

6. The image forming apparatus according to claim 5, further comprising
a sheet classifier that classifies sheets included in the one job into a plurality of groups on the basis of the image coverage rates of the sheets included in the one job, the image coverage rates each being calculated by the image coverage rate calculator, wherein
the sheet feeding tray switcher switches the sheet feeding trays depending oil a group classified by the sheet classifier.

7. The image forming apparatus according to claim 3, further comprising
a color gradation adjuster that performs color adjustment of an image to be formed on a sheet by using a color adjustment patch generated by the chart generator, wherein
the color adjustment patch is used as the adjustment chart.

8. The image forming apparatus according to claim 4, wherein
an image of a sheet is used as the adjustment chart, the sheet having a coverage rate close to the coverage rate set by the chart coverage rate setter among the image coverage rates of the sheets included in the one job, the image coverage rates each being calculated by the image coverage rate calculator.

9. The image forming apparatus according to claim 2, wherein
an image of a sheet is used as the adjustment chart, the sheet having a coverage rate close to the average image coverage rate among the image coverage rates of the sheets included in the one job, the image coverage rates each being calculated by the image coverage rate calculator.

10. The image forming apparatus according to claim wherein
an image of a sheet is used as the adjustment chart, the sheet having a highest coverage rate among the image coverage rates of the sheets included in the one job, the image coverage rates each being calculated by the image coverage rate calculator.

11. An image adjustment method for performing front and back adjustment of images to be formed on both sides of a sheet by using an adjustment chart,
the image adjustment method comprising:
calculating in advance an image coverage rate of the sheet included in one job to be executed by an image former, by an image coverage rate calculator included in an image forming apparatus;
determining a coverage rate of the adjustment chart to be formed on a front side of the sheet on a basis of the image coverage rate calculated by the image coverage rate calculator, by a chart coverage rate determiner included in the image forming apparatus;
forming and fixing an image of the adjustment chart on the sheet, by the image former included in the image forming apparatus;
reading the adjustment chart formed on the sheet, by an image reader included in the image forming apparatus; and
performing the front and back adjustment on a basis of the adjustment chart that is formed and fixed by the image former and read by the image reader, by a front and back adjuster included in the image forming apparatus.

12. A non-transitory recording medium storing a computer readable program causing a computer included in an image forming apparatus that performs front and back adjustment of images to be formed on both sides of a sheet by using an adjustment chart to execute:
calculating in advance an image coverage rate of the sheet included in one job to be executed by an image former, by an image coverage rate calculator included in an image forming apparatus;
determining a coverage rate of the adjustment chart to be formed on a front side of the sheet on a basis of the image coverage rate calculated by the image coverage rate calculator, by a chart coverage rate determiner included in the image forming apparatus;
forming and fixing an image of the adjustment chart on the sheet, by the image former included in the image forming apparatus;
reading the adjustment chart formed on the sheet, by an image reader included in the image forming apparatus; and.
performing the front and back adjustment on a basis of the adjustment chart that is formed and fixed by the image former and read by the image reader, by a front and back adjuster included in the image forming apparatus.
